(19) United States
(12) Patent Application Publication
(10) Pub. No.: US 2025/0346502 A1
(43) Pub. Date: Nov. 13, 2025

(54) METHOD FOR ADSORBING OF HEAVY METAL IONS USING A MAGNETIC IONIC LIQUID ADSORBENT

(71) Applicant: KING FAHD UNIVERSITY OF PETROLEUM AND MINERALS, Dhahran (SA)

(72) Inventors: Khalid ALHOOSHANI, Dhahran (SA); Ahmed Abdi HASSAN, Dhahran (SA); Abdulkadir TANIMU, Dhahran (SA)

(73) Assignee: KING FAHD UNIVERSITY OF PETROLEUM AND MINERALS, Dhahran (SA)

(21) Appl. No.: 19/275,347

(22) Filed: Jul. 21, 2025

Related U.S. Application Data
(62) Division of application No. 17/847,674, filed on Jun. 23, 2022.

(51) Int. Cl. C02F 1/28; B01J 20/02; B01J 20/28; C02F 1/62; C02F 101/20

(52) U.S. Cl. CPC C02F 1/28; B01J 20/0288; B01J 20/28004; C02F 1/62; C02F 2101/20

(57) ABSTRACT

An adsorbent and a method of preparing the adsorbent are described. The adsorbent includes a 2-anthracene ammonium magnetic ionic liquid (MIL), and a [FeCl₄]⁻ or a [CoCl₃]⁻ ion. The adsorbents, 2-anthracene ammonium tetrachloroferrate (III) ([2 AA] FeCl₄) and 2-anthracene ammonium trichlorocobaltate (II) ([2 AA] CoCl₃), are prepared by protonation of 2-aminoanthracene, followed by complexation with FeCl₃/CoCl₂. The adsorbent of the present disclosure is effective in removing contaminants such as heavy metal ions from an aqueous system in a cost-efficient and selective manner.

### BACKGROUND

### Technical Field

The present disclosure is directed to magnetic ionic liquids, and particularly to 2-anthracene ammonium-based magnetic ionic liquids, methods of use for selective removal of heavy metals from water and methods of preparing the magnetic ionic liquids.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

More than 70% of the problems in most developing countries are due to water pollution and contamination. Such contaminants are dyes, heavy metals, pesticides, pharmaceutical and drug-related pollutants. Heavy metals are metals or metalloids with an atomic density greater than 4000 kg/m³. They are generally toxic even at trace concentrations; good examples are mercury, lead, cadmium, arsenic, and chromium. Therefore, the proper removal of heavy metals from sub-surface and wastewater is essential.

Various methods for the removal of heavy metals from water include adsorption, membrane separation, advanced oxidation, ion exchange, filtration, chemical oxidation, biological processes, reverse osmosis (RO), etc. However, adsorption is the most preferred method due to its low cost and simplicity of approach. Conventionally, activated carbon was the widely used adsorbent due to its high porosity. However, the high cost associated with it is a significant drawback. In recent years, ionic liquids and magnetic ionic liquids (MILs) have been increasingly used as adsorbents to adsorb heavy metals. However, there is still a need to develop cost-effective adsorbents with high selectivity to remove heavy metals from wastewater, groundwater, and industrial effluents.

It is one object of the present disclosure to provide an adsorbent effective for removing contaminants from aqueous solution.

### SUMMARY

In an exemplary embodiment, an adsorbent is described. The adsorbent includes a 2-anthracene ammonium magnetic ionic liquid (MIL).

In some embodiments, the 2-anthracene ammonium MIL comprises a [FeCl₄]⁻ or a [CoCl₃]⁻ ion.

In some embodiments, the 2-anthracene ammonium MIL comprises a [FeCl₄]⁻ or a [CoCl₃]⁻ ion and has thermal stability up to a temperature of 400° C.

In some embodiments, the 2-anthracene ammonium trichlorocobaltate is in the form of nanoflakes having an average diameter of 2 to 10 μm before adsorption.

In some embodiments, the 2-anthracene ammonium trichlorocobaltate is in the form of nanoflakes having an average thickness of 1 to 8 μm before adsorption.

In some embodiments, the 2-anthracene ammonium trichlorocobaltate has 2 to 8 times thicker nanoflakes after adsorption of a contaminant.

In some embodiments, the adsorbent has an adsorption capacity in the range of 3 to 80 mg/g for 2-anthracene ammonium tetrachloroferrate.

In some embodiments, the adsorbent has an adsorption capacity in the range of 10 to 80 mg/g for 2-anthracene ammonium trichlorocobaltate.

In an exemplary embodiment, a method of reducing a contaminant concentration from an aqueous solution with the adsorbent is described. The method includes mixing the adsorbent with the aqueous solution containing contaminants.

In some embodiments, the concentration of the contaminant in the aqueous solution is 25 to 100 ppm.

In some embodiments, the aqueous solution is at 10 to 50° C.

In some embodiments, the adsorbent reduces the contaminant concentration from the aqueous solution by adsorption.

In some embodiments, the 2-anthracene ammonium trichlorocobaltate has 0.2 to 6 times higher adsorption capacity compared to the 2-anthracene ammonium tetrachloroferrate. In some embodiments, the contaminants are metal ions.

In some embodiments, the metal ion is at least one metal selected from the group of Cd²⁺, As³⁺, Pb²⁺ and Cr³⁺.

In some embodiments, the 2-anthracene ammonium trichlorocobaltate adsorbent maintains an adsorption efficiency of at least 90% for removing metal ions over at least 5 purification cycles.

In an exemplary embodiment, a method of synthesis of 2-anthracene ammonium tetrachloroferrate or 2-anthracene ammonium trichlorocobaltate is described. The method includes mixing HCl with 2-aminoanthracene to form an anthracene-2-aminium chloride intermediate, and further washing the intermediate. The method further mixing FeCl₃ or CoCl₂ with the intermediate after the washing to form 2-anthracene ammonium tetrachloroferrate or 2-anthracene ammonium trichlorocobaltate, respectively; and further washing 2-anthracene ammonium tetrachloroferrate or 2-anthracene ammonium trichlorocobaltate.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a synthesis procedure for 2-anthracene ammonium tetrachloroferrate (III) and 2-anthracene ammonium trichlorocobaltate (II), according to certain embodiments;

FIG. 2 is a ¹H-nuclear magnetic resonance (NMR) spectrum of 2-aminoanthracene, according to certain embodiments;

FIG. 3 is a ¹H-NMR spectrum of anthracene-2-aminium chloride intermediate, according to certain embodiments;

FIG. 4A shows Fourier Transform Infrared (FTIR) spectrum of 2-aminoanthracene, intermediate anthracen-2-aminium chloride, 2-anthracene ammonium tetrachloroferrate (III), 2-anthracene ammonium trichlorocobaltate (II), according to certain embodiments;

FIG. 4B shows a thermogravimetric analysis (TGA) decomposition curve of [2-AA] FeCl₄ and [2-AA] CoCl₃, according to certain embodiments;

FIG. 5A shows UV-vis spectra of 2-aminoanthracene, intermediate anthracen-2-aminium chloride, 2-anthracene ammonium tetrachloroferrate (III), and 2-anthracene ammonium trichlorocobaltate (II), according to certain embodiments;

FIG. 5B shows the zeta potential of MIL, 2-anthracene ammonium tetrachloroferrate (III), and 2-anthracene ammonium trichlorocobaltate (II), according to certain embodiments;

FIG. 6A shows the magnetization of [2-AA] FeCl₄ as a function of the applied magnetic field at a temperature range of 10-300 K, according to certain embodiments;

FIG. 6B shows the magnetization of [2-AA] CoCl₃ as a function of the applied magnetic field at a temperature of 5-300 K, according to certain embodiments;

FIG. 6C shows magnetization of [2-AA] CoCl₃ as a function of temperature in an applied magnetic field range of-0.2-1000 Oe, according to certain embodiments;

FIG. 6D shows magnetization of [2-AA] FeCl₄ as a function of temperature under an applied magnetic field of 50-1000 Oe, according to certain embodiments;

FIG. 7A shows scanning electron microscope (SEM) micrographs of [2-AA] CoCl₃ MIL adsorbent before absorption, according to certain embodiments;

FIG. 7B shows energy dispersive X-ray diffractogram (EDX) images of [2-AA] CoCl₃ MIL adsorbent before absorption in 5 μm magnification, according to certain embodiments;

FIG. 7C shows SEM micrographs of [2-AA] CoCl₃ MIL adsorbent after absorption, according to certain embodiments;

FIG. 7D shows EDX images of [2-AA] CoCl₃ MIL adsorbent after absorption in 5 μm magnification, according to certain embodiments;

FIG. 8A shows the adsorption performance of the MIL adsorbents, according to certain embodiments;

FIG. 8B shows an effect of [2-AA] CoCl₃ dosage on adsorption performance, according to certain embodiments;

FIG. 9 shows the effect of solution pH on the adsorption of the metal ions by the [2-AA] CoCl₃ MIL, according to certain embodiments;

FIG. 10 shows the effects of contact time on the adsorption of the heavy metal ions by the [2-AA] CoCl₃ MIL, according to certain embodiments;

FIG. 11 shows the effects of different initial concentrations of each of the targeted metal ions on their adsorption by [2-AA] CoCl₃ MIL, according to certain embodiments;

FIG. 12A shows pseudo-first-order plots for the targeted metal ions adsorption on [2-AA] CoCl₃ MIL, according to certain embodiments;

FIG. 12B shows pseudo-second-order plots for the targeted metal ions adsorption on [2-AA] CoCl₃ MIL, according to certain embodiments;

FIG. 13A shows Langmuir for the targeted metal ions adsorption on [2-AA] CoCl₃, according to certain embodiments;

FIG. 13B shows Freundlich isotherms for the targeted metal ions adsorption on [2-AA] CoCl₃ MIL, according to certain embodiments;

FIG. 14 shows selective adsorption of targeted metal ions by [2-AA] CoCl₃ in a mixed component solution, according to certain embodiments;

FIG. 15 shows the regeneration and reuse of MIL, [2-AA] CoCl₃ for 6 consecutive times for the adsorption of the metal ions Cd (II), As (II), Pb (II), and Cr (II) by using 1M HNO₃, according to certain embodiments; and

FIG. 16 shows the adsorption performance of [2-AA] CoCl₃ MIL adsorbent using real raw underground and wastewater samples spiked with 150 ppm each of the targeted metal ions, according to certain embodiments.

### DETAILED DESCRIPTION

The present disclosure will be better understood with reference to the following definitions.

It will be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the drawings, like reference numerals designate identical or corresponding parts throughout the several views. Further, as used herein, the words “a,” “an” and the like generally carry a meaning of “one or more,” unless stated otherwise. Also, the use of “or” means “and/or” unless stated otherwise. Similarly, “comprise,” “comprises,” “comprising” “include,” “includes,” and “including” are interchangeable and not intended to be limiting.

Furthermore, the terms “approximately,” “approximate,” “about,” and similar terms generally refer to ranges that include the identified value within a margin of 20%, 10%, or preferably 5%, and any values there between. For example, if a stated value is about 8.0, the value may vary in the range of 8±1.6, ±1.0, ±0.8, ±0.5, ±0.4, ±0.3, ±0.2, or ±0.1.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it also describes subranges for Parameter X including 1-9, 1-8, 1-7, 2-9, 2-8, 2-7, 3-9, 3-8, 3-7, 2-8, 3-7, 4-6, or 7-10, 8-10 or 9-10 as mere examples. A range encompasses its endpoints as well as values inside of an endpoint, for example, the range 0-5 includes 0, >0, 1, 2, 3, 4, <5 and 5.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

An adsorbent including a 2-anthracene ammonium magnetic ionic liquid (MIL) is described. Magnetic ionic liquids include an organic cation and an inorganic or organic anion having melting points at or below 100° C. 2-anthracene ammonium magnetic ionic liquid is a solid state at 20 to 30° C. which makes it more favorable as a sorbent with larger surface area compared to liquid state. 2-anthracene ammonium magnetic ionic liquid has an average melting point in a range of 60 to 90° C., preferably 70° C. High melting point above 20 to 30° C. can be attributed to the rigidity of the benzene rings due to conjugation arising from the rings. Magnetic ionic liquids have paramagnetic properties by themselves without the need of adding magnetic particles. These paramagnetic properties are induced by the anion, the cation or both. Most common paramagnetic ionic liquids are those that contain transition metal or lanthanide complexes in their anion structure. These tuneable fluids present unique physicochemical properties, resulting in materials responsive to an external magnetic field.

In an embodiment, the 2-anthracene ammonium MIL of the present disclosure includes a [FeCl₄]⁻ or a [CoCl₃]⁻ ion. In an embodiment, the 2-anthracene ammonium includes [FeCl₄]⁻ ion as an anionic component. In a preferred embodiment, the 2-anthracene ammonium includes [CoCl₃]⁻ ion as an anionic component. In an embodiment, the anionic component is a combination of [FeCl₄]⁻ and a [CoCl₃]⁻ ion.

The MIL of the present disclosure, i.e., 2-anthracene ammonium tetrachloroferrate and 2-anthracene ammonium trichlorocobaltate, may be used as an adsorbent in a chromatographic technique, when MILs are immobilized onto the solid supports.

In an embodiment, the adsorbent is 2-anthracene ammonium tetrachloroferrate. It has an adsorption capacity in the range of 3 to 100 mg/g, preferably 3 to 96 mg/g, preferably 3 to 90 mg/g, preferably 3 to 85 mg/g, preferably 3 to 80 mg/g.

In a preferred embodiment, the adsorbent is 2-anthracene ammonium trichlorocobaltate. The 2-anthracene ammonium trichlorocobaltate is preferably in the form of nanoflakes having an average diameter of 1 to 25 μm, preferably 1 to 20 μm, preferably 1 to 15 μm, preferably 2 to 10μm prior to adsorption. In another embodiment, the 2-anthracene ammonium trichlorocobaltate is in the form of nanoflakes having an average thickness of 0.5 to 15 μm, preferably 1 to 10 μm, preferably 1 to 9 μm, preferably 1 to 8 μm prior to adsorption. In an embodiment, the nanoflakes of 2-anthracene ammonium trichlorocobaltate are 1.5 to 12 times, preferably 2 to 10 times, preferably 2 to 9 times, preferably 2 to 8 thicker after adsorption than before adsorption. In an embodiment, the 2-anthracene ammonium trichlorocobaltate has an adsorption capacity in the range of 10 to 120 mg/g, preferably 10 to 110 mg/g, preferably 10 to 100 mg/g, preferably 10 to 90 mg/g, preferably 10 to 80 mg/g.

The adsorbent of the present disclosure (2-anthracene ammonium tetrachloroferrate or 2-anthracene ammonium trichlorocobaltate) may be prepared by mixing HCl with 2-aminoanthracene to form an anthracene-2-aminium chloride intermediate. The intermediate was prepared by mixing 1 to 5 M, preferably 1 to 4 M, preferably 2 to 4 M, preferably 3 M HCl with 2-aminoanthracene under constant stirring for 1 to 10 hours, preferably 1 to 8 hours, preferably 2 to 6 hours, preferably 3 to 5 hours, preferably 4 hours at 20 to 30° C. The method further includes washing the precipitated intermediate. In an embodiment, the intermediate may be washed with an organic solvent or an inorganic solvent. The organic solvent can include one or more selected from tetrahydrofuran, ethyl acetate, dimethylformamide, dichloromethane, acetone, acetonitrile, chloroform, and dimethyl sulfoxide. In a preferred embodiment, the intermediate was washed with an inorganic solvent which may include ammonium hydroxide solution, preferably water, and more preferably, deionized water. This was done to remove the excess acid in the intermediate till the pH of the intermediate was about 3.5.

The method further includes mixing FeCl₃ or CoCl₂ as a solution with the intermediate after the washing to form 2-anthracene ammonium tetrachloroferrate or 2-anthracene ammonium trichlorocobaltate, respectively. In an embodiment, an equimolar concentration of the FeCl₃ or CoCl₂ and the intermediate were used to prepare 2-anthracene ammonium tetrachloroferrate or 2-anthracene ammonium trichlorocobaltate. The method further includes washing 2-anthracene ammonium tetrachloroferrate or 2-anthracene ammonium trichlorocobaltate. The washing was preferably performed with an inorganic solvent, such as water or ammonium hydroxide solution.

A method for reducing a contaminant concentration in an aqueous solution with the adsorbent of the present disclosure is described. The method includes mixing the adsorbent with the aqueous solution containing one or more contaminants. In an embodiment, the adsorbent is 2-anthracene ammonium trichlorocobaltate. In another embodiment, the adsorbent is 2-anthracene ammonium tetrachloroferrate. The adsorbents may be used to remove the contaminants in an aqueous solution. In an embodiment, the aqueous solution may be wastewater, groundwater, surface water, and runoff from agricultural activities. In an embodiment, the aqueous solution is at 2 to 80° C., preferably 3 to 75° C., preferably 4 to 70° C., preferably 5 to 65° C., preferably 10 to 60° C., preferably 10 to 55° C., preferably 10 to 50° C. The contaminants may be metal ions. The metal ion is preferably at least one metal selected from the group of Cd²⁺, As³⁺, Pb²⁺, and Cr³⁺. In an embodiment, the concentration of the contaminant is 10 to 150 ppm, preferably 15 to 140 ppm, preferably 20 to 130 ppm, preferably 25 to 120 ppm, preferably 25 to 110 ppm, preferably 25 to 100 ppm. In other words, the adsorbent can effectively remove contaminants in the aqueous solution at a concentration as low as 10 to 150 ppm, preferably 15 to 140 ppm, preferably 20 to 130 ppm, preferably 25 to 120 ppm, preferably 25 to 110 ppm, preferably 25 to 100 ppm. Adsorbents have preferentially removed the targeted metal ions with adsorption capacity in the range of 3-70 mg/g, preferably 5.73-55.5 mg/g for [2-AA] FeCl₄ and 20-60 mg/g, preferably 23.6-56.8 mg/g for [2-AA] CoCl₃. Overall, both adsorbents have shown higher selectivity towards As³⁺, Pb²⁺ and Cr³⁺ with stronger binding sites compared to Cd²⁺. However, based on the obtained results, the [2-AA] CoCl₃ was adopted as the best adsorbent for the removal of these heavy metal ions.

The adsorbent reduces the contaminant concentration from the aqueous solution by adsorption. In an embodiment, the 2-anthracene ammonium trichlorocobaltate has 0.1 to 10 times, preferably 0.2 to 9 times, preferably 0.2 to 8 times, preferably 0.2 to 7 times, preferably 0.2 to 6 times higher adsorption capacity compared to the 2-anthracene ammonium tetrachloroferrate based on the same ionic contaminant.

Thermal stabilities of MILs are verified by TGA analyzing the temperatures at which the MILs start to decompose, along with the extent of mass change determined using thermogravimetry. The adsorbent of the present disclosure has thermal stability measure by TGA decomposition up to 700-800° C., preferably 600-700° C., preferably 500-600° C., preferably 400-500° C., preferably 400° C. The TGA decomposition for both 2-anthracene ammonium trichlorocobaltate and 2-anthracene ammonium tetrachloroferrate show similar decomposition pattern, with gradual decomposition up to 400° C. for [2-AA] CoCl₃ and 500° C. for [2-AA] FeCl₄.

[2-AA] FeCl₄ is ferromagnetic while [2-AA] CoCl3 is superparamagnetic. The superparamagnetic property of [2-AA] CoCl₃ is attributed to crystallite size reduction, which decreases the anisotropy energy, hence favoring the superparamagnetism of the material. In addition, the cobalt-containing MILs of the present disclosure can have high saturation magnetization and high two-curie temperature due to allotropic characteristics of the element. In the case of [2-AA] FeCl₄ ferromagnetic properties can be associated with the presence of iron which has a curie point at 770° C. and changes its crystalline structure above the curie point. Furthermore, a linear relationship between the magnetic field and the magnetization has been recorded and obtained at room temperature indicating that both MILs are magnetic. The magnetic susceptibility was found to be 1.17 and 1.16 for [2-AA] FeCl₄ and [2-AA] CoCl₃ respectively. This implies that both MILs have magnetic properties that can be attributed to iron and cobalt due to their structures which allow their electrons to line up more easily forming the magnetic field of the materials.

The adsorbent of the present disclosure can be used multiple times with high efficiency and selectivity towards the metal ions. In an embodiment, the 2-anthracene ammonium trichlorocobaltate adsorbent maintains an adsorption efficiency of at least 99%, preferably 98%, preferably 97%, preferably 96%, preferably 95%, preferably 94%, preferably 93%, preferably 92%, preferably 90% for removing metal ions over at least 10 purification cycles, preferably 9 purification cycles, preferably 8 purification cycles, preferably 7 purification cycles, preferably 6 purification cycles, preferably 5 purification cycles.

Aspects of the present disclosure are directed towards the facile synthesis of two 2-anthracene ammonium-based magnetic ionic liquids (MILs), 2-anthracene ammonium tetrachloroferrate (III) ([2 AA] FeCl₄) and 2-anthracene ammonium trichlorocobaltate (II) ([2 AA] CoCl₃) by protonation of 2-aminoanthracene, followed by complexation with FeCl₃/CoCl₂. The MILs were tested for adsorptive removal of Cd²⁺, As³⁺, Pb²⁺, and Cr³⁺ from water sources. The results indicate that upon treatment with a 1 mg, preferably 2 mg, preferably 3 mg, preferably 4 mg, preferably 5 mg, preferably 6 mg, preferably 7 mg, preferably 8 mg, preferably 9 mg, preferably 10 mg dosage of MILs in a 1 mL, preferably 2 mL, preferably 3 mL, preferably 4 mL, preferably 5 mL, preferably 6 mL, preferably 7 mL, preferably 8 mL, preferably 10 mL aqueous solution of 70 ppm, preferably 65 ppm, preferably 60 ppm, preferably 55 ppm, preferably 50 ppm each of Cd²⁺, As³⁺, Pb²⁺, and Cr³⁺, the adsorption capacity (mg/g) was in the range of 4-70, preferably 4-65, preferably 5-60, preferably 5-57, preferably 5-56, preferably 5.5-55.8, preferably 5.73-55.5 and 22-80, preferably 22-75, preferably 22-70, preferably 22-65, preferably 22-60, preferably 23.6-56.8 for [2 A-A] FeCl₄ and [2A-A] CoCl₃, respectively. The [2 A-A] CoCl₃ was more effective at a pH 7-9, and equilibrium adsorption was achieved after 10 minutes, preferably 5 minutes of contact time. The adsorption process proceeded via the pseudo-second-order pathway. The Langmuir isotherm model was the best fit for the adsorption process (with qₘₐₓ=200-400 mg/g, preferably 210-390 mg/g, preferably 215-380 mg/g, preferably 220-370 mg/g, preferably 225-360 mg/g, preferably 227-357 mg/g) for all the targeted metal ions. The [2 A-A] CoCl₃ adsorbent demonstrated practicality with large distribution and selectivity coefficients of the targeted ions and up to ten times regeneration.

### EXAMPLES

The following examples describe and demonstrate exemplary embodiments of the magnetic ionic liquids for the adsorption of heavy metal ions, as described herein. The examples are provided solely for the purpose of illustration and are not to be construed as limitations of the present disclosure, as many variations thereof are possible without departing from the spirit and scope of the present disclosure.

Materials and methods

All chemicals were used as received without further purification. Ethanol, hydrochloric acid, calcium chloride, potassium chloride, magnesium chloride, sodium chloride, cobalt (II) chloride hexahydrate, and 2-aminoanthracene were received from Sigma-Aldrich, USA. Ferric chloride was purchased from Fluka Analytical, cadmium nitrate tetrahydrate, arsenic trichloride, lead (II) nitrate, and chromium (III) nitrate nonahydrate (99%) were acquired from Merck Chemicals, USA.

Synthesis of 2-anthracene Ammonium-based Magnetic Ionic Liquids

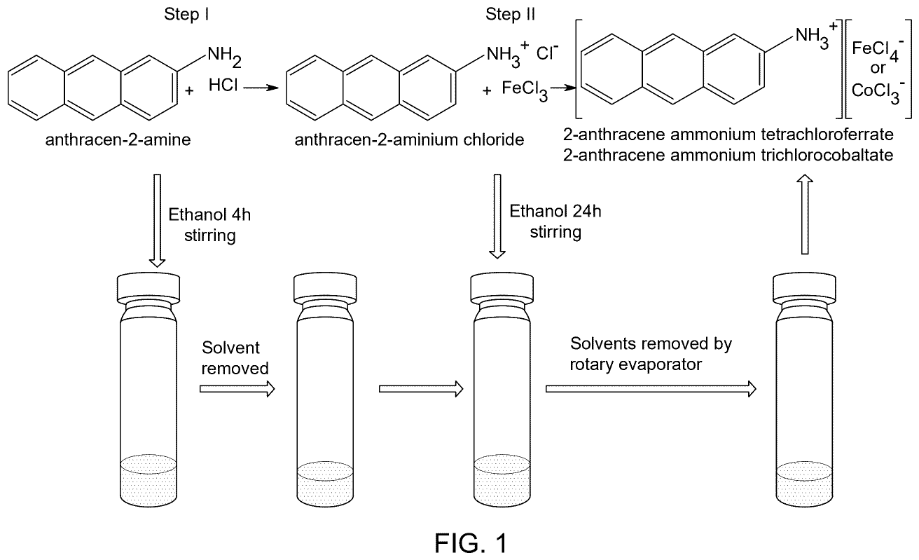

The synthesis procedure involved two steps. In the first step, 3M HCl in ethanol solvent was added to 2-aminoanthracene ([2-AA]) in a round bottom flask, and the solution was vigorously stirred for 4 h to form anthracene-2-aminium chloride ([2-AA] Cl) as an intermediate. The ethanol solvent in the reaction flask was removed using a rotary evaporator. Further, the [2-AA] Cl intermediate was washed with de-ionized water to about pH 3.5 to remove the excess acid. Thereafter, an equimolar amount of FeCl₃ or CoCl₂ in ethanol was added to the flask containing the [2-AA] Cl intermediate and stirred for 24 h to form 2-anthracene ammonium tetrachloroferrate (III) or 2-anthracene ammonium trichlorocobaltate (II) respectively. The final product was washed several times until there were no traces of Fe³⁺ or Co²⁺ in the supernatant liquid, as shown in FIG. 1.

Characterization of 2-anthracene Ammonium-based Magnetic Ionic Liquids

The ¹H NMR spectra of the starting material 2-AA and the intermediate [2-AA] Cl were recorded on the Bruker NMR 400 MHz model AVANCE 3. Fourier Transform Infrared (FTIR) spectra of the 2-AA, [2-AA] Cl intermediate, and the ionic liquid adsorbents were recorded between 4000 cm−1 and 400 cm⁻¹ using the Smart iTR NICOLET iS10 model. The thermogravimetric (TGA) analysis was carried out on a thermogravimetric analyzer model SDT Q600 instrument. About 10 mg of the MIL was heated over a temperature range of 30 to 900° C. in an alumina pan at the rate of 10° C./min with a nitrogen flow of 50 mL/min to obtain the decomposition curve. The UV/Vis absorption spectrum was measured on a UV/Vis spectrophotometer (Genesys 10S Thermo Fisher Scientific, USA). The adsorbents were dissolved in ethanol to form about 1×10⁻³ M concentration, then inserted into the sample cuvettes for spectrum measurement. The Zeta potential of the MIL adsorbents was recorded using the model Analyzer Zeta PALS. Six different pH values in the range 2-12 were studied as a function of zeta potential (mV). DaynaCool (Quantum Design, US) instrument was used to measure the magnetization properties of the MILs. About 27.2 mg of each sample was loaded, and both temperature and magnetic field varied. The morphology of [2-AA] CoCl₃ MIL before and after adsorption was studied using the Scanning Electron Microscopy (SEM) (JEOL JSM-6610LV instrument), and the constituent elements (in weight percent) were determined using Energy Dispersive X-Ray analysis (EDX).

### Heavy Metals Removal Test

The heavy metals' adsorption experiment was carried out at room temperature in a batch system. A 10 mL aqueous solution containing the mixture of four heavy metal ions (Cd²⁺, As³⁺, Pb²⁺, and Cr³⁺) with initial concentrations ranging from 50-350 ppm was added to a 50 mL vial, and adsorbent (5-30 mg) was subsequently dispersed into the heavy metal ions solution in the vial and sealed. The solution mixture was stirred for 5 minutes to 24 h until equilibrium was reached. Afterward, the adsorbent was isolated by centrifuging at 3500 rpm, and the supernatant was analyzed for the presence of heavy metals using ICP-OES (Plasma Quant® PQ 9000). The adsorption capacity (QE, mg/g) of the heavy metal ions was determined using equation (1) below:

$${q}_{e} = ( \frac{V ( {C}_{i} - {C}_{e} )}{m} ) \qquad ( 1 )$$

where V (L) represents the volume of the heavy metals' solution, Cᵢ and Cₑ represent the initial and equilibrium concentrations of the solutions in mg/L. The m represents the mass of the adsorbents.

The effects of adsorption parameters such as pH, adsorbent dosage, contact time, and concentration on heavy metal ions were studied following the same approach. The evaluated adsorption conditions were extended to real wastewater and raw groundwater samples from the Khobar wastewater treatment plant and the King Fahd University of Petroleum and Minerals (KFUPM) maintenance department. The competitive adsorption of other metal ions (K⁺, Na⁺, Ca²⁺, and Mg²⁺) and reusability studies of the adsorbents was performed. Characterization of 2-anthracene ammonium-based MIL adsorbents

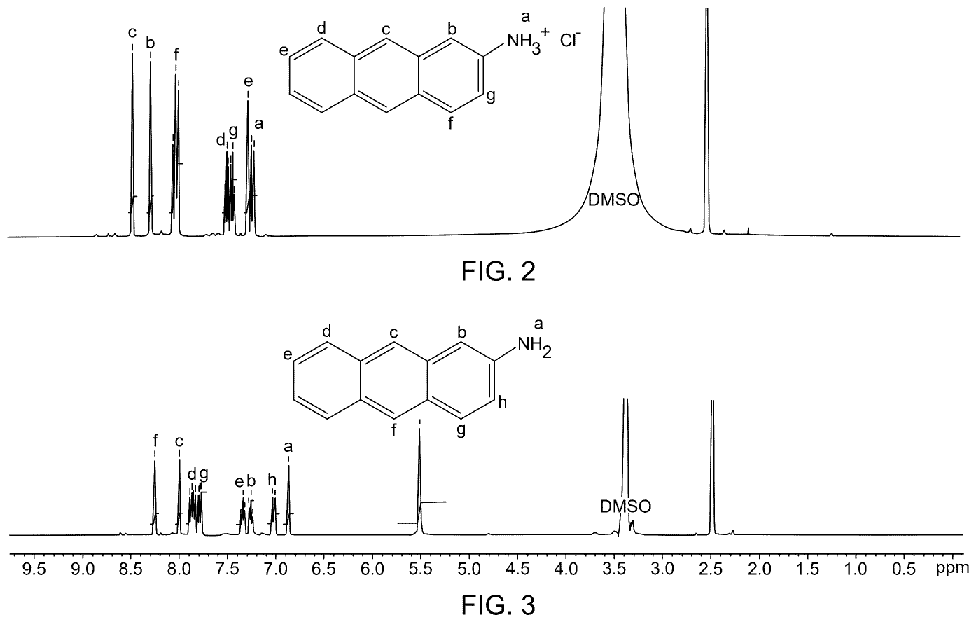

A ¹H NMR spectra of 2-AA (FIG. 3) and [2-AA] Cl intermediate (FIG. 2) are depicted. The 2-AA spectrum shows the amine N—H protons at the chemical shift of 5.5 ppm. After protonation, the N-H signal became very weak and was strongly shifted downfield to around δ=8-9. Similarly, all the C-H protons signals were downfield shifted by δ=0.3. No additional peaks were observed upon protonation of 2-AA to form [2-AA] Cl. The integral area peaks were directly proportional to the number of hydrogen atoms, implying the high purity of the [2-AA] Cl intermediate.

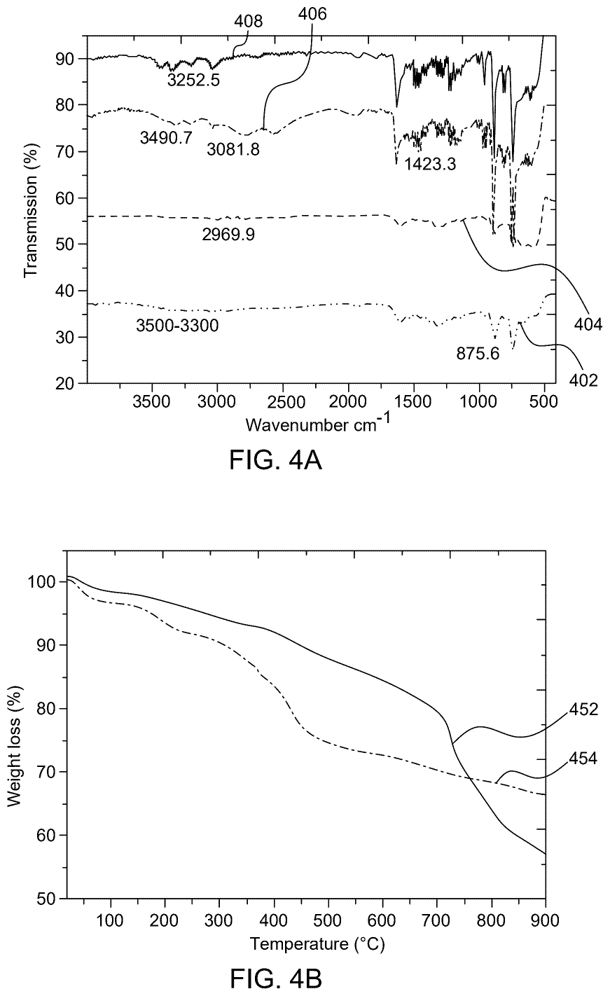

Referring to FIG. 4A, FT-IR spectrum of 2-aminoanthracene (408), intermediate anthracen-2-ammonium chloride (406), 2-anthracene ammonium tetrachloroferrate (III) (404), and 2-anthracene ammonium trichlorocobaltate (II) (402) is depicted. The functional groups present in 2-anthracene ammonium tetrachloroferrate (III) (404) and 2-anthracene ammonium trichlorocobaltate (II) (402) MIL adsorbents were elucidated using the FTIR. From FIG. 4A, the broadband observed between 3100-3400 cm⁻¹ is characteristic of the N—H bond stretching vibrations in the adsorbents. The band seen at 2969.9 cm⁻¹ are C—H stretching vibrations due to the anthracene C—Hs. The skeletal vibrations of the rings are found at 1423.3 cm⁻¹ to 1650 cm⁻¹, while the broadband at 3300-3500 cm⁻¹ in (402) and (404) is characteristic of OH stretching vibration due to the hygroscopic nature of the chlorides of cobalt and iron. The characteristic behavior of the two MILs is considered similar and confirms the formation of the complex metal chlorides.

Referring to FIG. 4B, a thermogravimetric (TGA) analysis of [2-AA] CoCl₃ (452) and [2-AA] FeCl₄ (454) MIL adsorbents is depicted. The TGA decomposition curve of both MILs shows a similar decomposition pattern, with gradual decomposition up to 400° C. for [2-AA] CoCl₃ and 500° C. for [2-AA] FeCl₄. The decomposition below these temperatures occurs in three steps-first at 70° C., which is ascribed to the melting point of the respective MILs, then at 150° C., which is assigned to the loss of hydrated water molecules, and the sharp decrease observed above 300° C. which is due to the decomposition of the respective MILs to form oxides. The synthesized MILs have shown remarkable thermal stability with less than 10% weight loss up to 300° C.

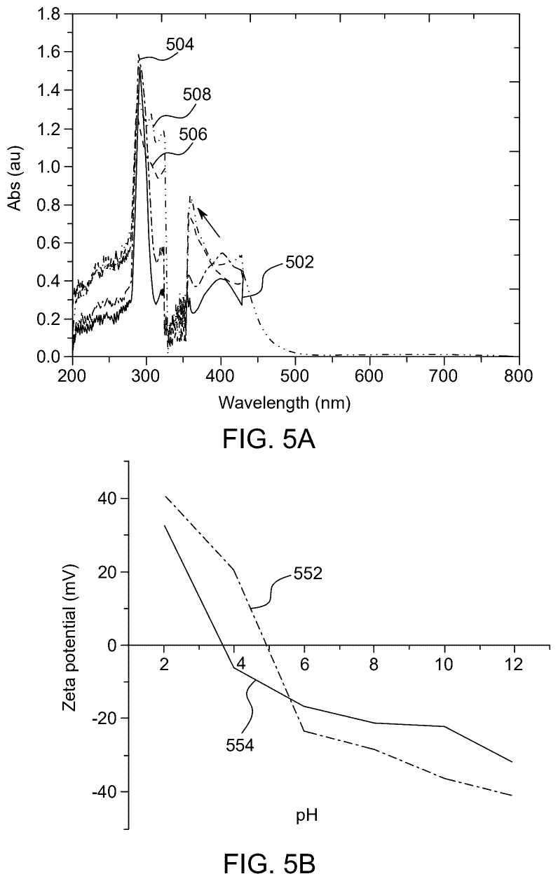

The UV/Vis spectra of [2-AA] CoCl₃ and [2-AA] FeCl₄-based MIL adsorbents were performed, and the results of this study are depicted in FIG. 5. Referring to FIG. 5A, superimposed UV-vis spectra of 2-aminoanthracene (502), anthracene-2-aminium chloride (504), 2-anthracene ammonium tetrachloroferrate (III) (506), and 2-anthracene ammonium trichlorocobaltate (II) (508) was presented in FIG. 5A. It was observed that all the spectra have a similar pattern. However, the [2-AA] CoCl₃ and [2-AA] FeCl₄ MIL adsorbents show sharp and well-resolved hypochromic shifts from 400 nm to 362 nm (indicated by the arrow). This can be associated with the stiffness introduced into the rings and confirms the formation of the corresponding complexes.

Referring to FIG. 5B, a zeta potential of [2-AA] CoCl₃ (552) and [2-AA] FeCl₄ (554) based MIL adsorbents is illustrated. The result of zeta potential measurement at different pHs is shown in FIG. 5B. The results indicate that by increasing the pH above the isoelectric point of 3.8 and 5.0, the interaction of the cationic moiety, anthracene-2-ammonium, with the alkaline medium decreases, which is due to the repulsive forces generated by the negative charges of the basic medium and FeCl₄-and similar behavior is observed in the [2-AA] CoCl₃ (552) and [2-AA] FeCl₄ (554) based MIL adsorbents. This indicates that the particles have both positive and negative charges. The higher zeta potential (mV) values obtained are due to the presence of the aromatic rings.

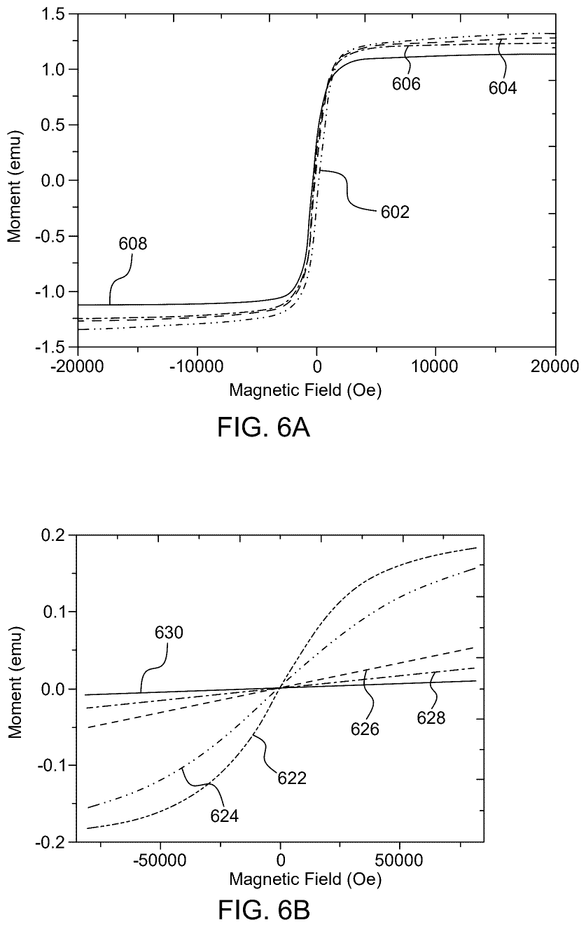

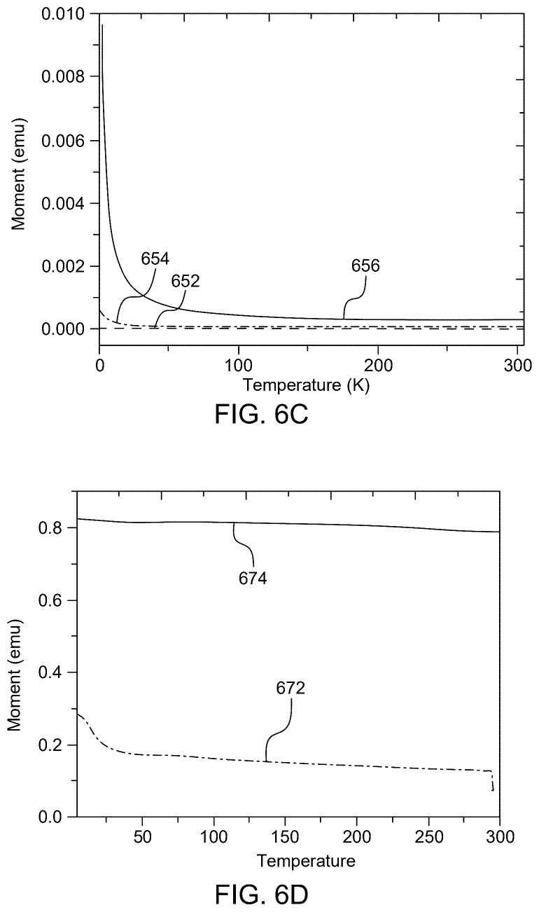

The magnetization properties of [2-AA] CoCl₃ and [2-AA] FeCl₄-based MIL adsorbents are depicted in FIG. 6. The magnetization of [2-AA] FeCl₄ as a function of the applied magnetic field at a temperature range of 10 K (602), 50 K (604), 100 K (606), and 300 K (608) is depicted in FIG. 6A; and the magnetization of [2-AA] CoCl₃ as a function of the applied magnetic field at a temperature of 5 K (622), 10 K (624), 50 K (626), 100 K (628), and 300 K (630), is depicted in FIG. 6B. The magnetization study indicates that [2-AA] FeCl₄ is ferromagnetic while is [2-AA] CoCl₃ superparamagnetic, as shown by the S-shaped curve in FIGS. 6A and 6B, respectively. The superparamagnetic property of [2-AA] CoCl₃ is attributed to the crystallite size reduction, which decreases the anisotropy energy, favoring the material's superparamagnetic property. In addition, high saturation magnetization and high two-curie temperature of cobalt-containing MIL can be due to the allotropic characteristics of the element. In the case of [2-AA], FeCl₄, which has depicted ferromagnetic properties, can be associated with the presence of iron with a curie point at 770° C. and changes its crystalline structure above the curie point.

The magnetization of [2-AA] CoCl₃ as a function of temperature in an applied magnetic field range of −0.2 Oe (652), 50 Oe (654), and 1000 Oe (656) is depicted in FIG. 6C; and the magnetization of [2-AA] FeCl₄ as a function of temperature under an applied magnetic field of 50 Oe (672) and 1000 Oe (674) is depicted in FIG. 6D. It can be observed that in both the samples, i.e., [2-AA] CoCl₃ and the [2-AA] FeCl₄, the temperature is directly proportional to the magnetic moment (FIGS. 6C and 6D), which agrees with Curie-Weiss law. Furthermore, a linear relationship between the magnetic field and the magnetization has been recorded and obtained at room temperature, indicating that both MILs are magnetic. The magnetic susceptibility was 1.17 and 1.16 for [2-AA] FeCl₄ and [2-AA] CoCl₃. This implies that both MILs have magnetic properties attributed to iron and cobalt due to their structures which allow their electrons to line up more easily, forming the magnetic field of the materials.

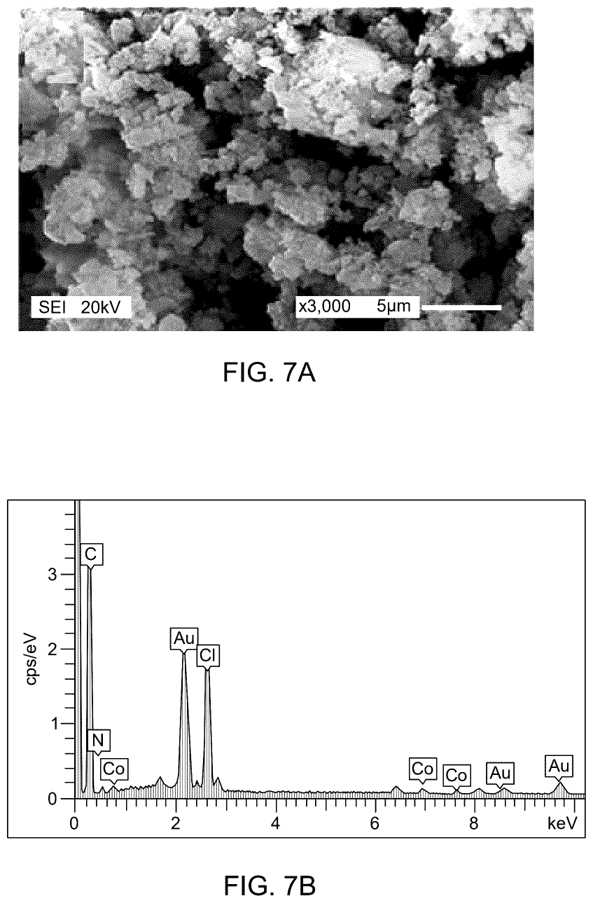

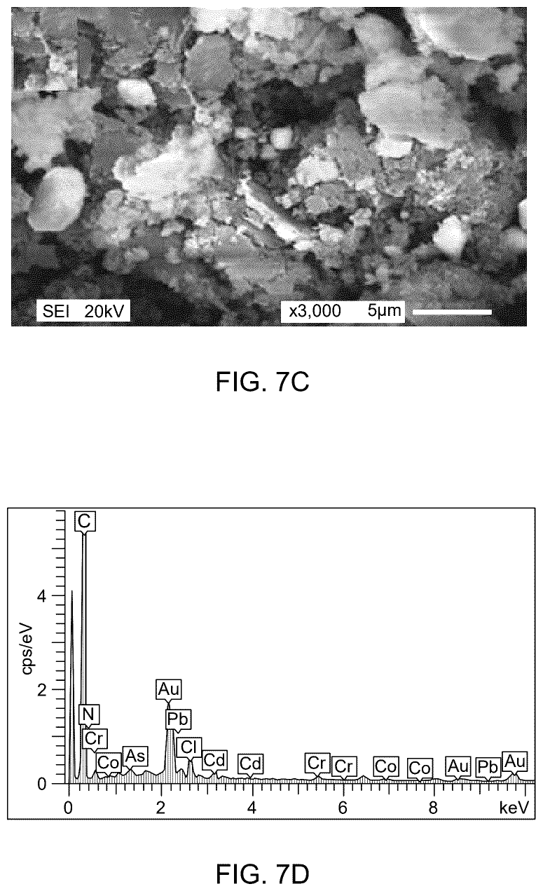

The morphological examination of [2-AA] CoCl₃-based MIL adsorbent was performed, and the results of this study are presented in FIG. 7. Adsorbents are in a form of irregular shaped and aggregated nanoflakes having an average thickness of 0.1 to 20 μm, with 0.1 to 20 μm diameters of holes. The SEM image of [2-AA] CoCl₃ based MIL before adsorption shows microparticle sizes with a non-spherical, irregular shape, generally with fine texture, and non-uniform surface morphology (FIG. 7A). The thicker crystal-like structure with irregular shapes and aggregated nanoflakes having an average thickness of 1 to 20 μm, with 0.1 to 6 μm diameters of holes observed after adsorption (FIG. 7B) is probably due to the adsorbed heavy metal ions on the surface of the [2-AA] CoCl₃-based MIL adsorbent. In addition, the EDX spectrum shown in (FIG. 7C) confirms the presence of all the expected elements in their stoichiometric weight percentages in the [2-AA] CoCl₃-based MIL adsorbent, while the EDX spectrum shown in FIG. 7D confirms the adsorption of the targeted heavy metal ions on the surface of [2-AA] CoCl₃ MIL adsorbent after the adsorption process.

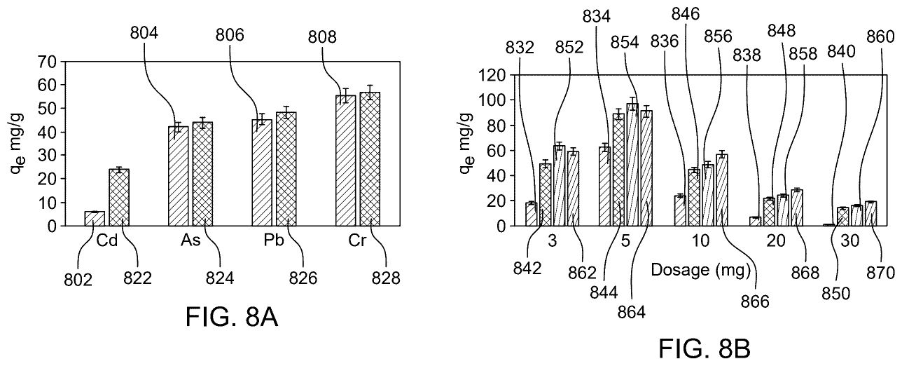

The adsorption capacity of MIL adsorbents was studied, and the results of this study are illustrated in FIG. 8A. The adsorption of heavy metal ions (Cd²⁺, As³⁺, Pb²⁺, and Cr³⁺) was studied using 10 mg of either [2-AA] CoCl₃ or [2-AA] FeCl₄ based MIL adsorbents dispersed in 10 mL of metal ions containing solution (50 ppm each) and stirred for 24 h contact time producing 0 to 5 ppm concentration of metal ions containing solutions. To elaborate, the effect of [2-AA] FeCl₄ based MIL adsorbent on heavy metal ions was studied using 10 mg of [2-AA] FeCl₄ based MIL adsorbent in 10 mL of Cd²⁺ (802), As³⁺ (804), Pb²⁺ (806), and Cr³⁺ (808) containing solution. Similarly, the effect of [2-AA] FeCl₄ based MIL adsorbent on heavy metal ions was studied using 10 mg of [2-AA] CoCl₃ based MIL adsorbent in 10 mL of Cd²⁺ (822), As³⁺ (824), Pb²⁺ (826), and Cr³⁺ (828) containing solution, respectively. The results indicate that both adsorbents ([2-AA] CoCl₃ or [2-AA] FeCl₄ have preferentially removed the targeted metal ions with adsorption capacity in the range of 5.73-55.5 mg/g for [2-AA] FeCl₄ and 23.6-56.8 mg/g for [2-AA] CoCl₃. The stability against hydrolysis coming from carbon bond and cobalt bond in [2-AA] CoCl₃ is considered responsible for the relatively higher adsorption performance of the [2-AA] CoCl₃ when compared to the [2-AA] FeCl₄ counterpart, and this can be attributed to d(z2) orbital which is occupied. Both adsorbents have shown higher selectivity towards As³⁺, Pb²⁺, and Cr³⁺ with stronger binding sites than Cd²⁺.

Further, the effect of [2-AA] CoCl₃ dosage on its adsorption capacity was studied, and the results of this study are depicted in FIG. 8B. The effect of [2-AA] CoCl₃ dosage on its adsorption capacity to remove Cd²⁺, As³⁺, Pb²⁺, and Cr³⁺ was studied by varying the adsorbent dosage from 3-30 mg, particularly 3 mg, 5 mg, 10 mg, 20 mg, and 30 mg. To elaborate, the effect of [2-AA] CoCl₃ dosage on its adsorption capacity to remove Cd²⁺ was studied with the adsorbent dosage of 3 mg (832), 5 mg (834), 10 mg (836), 20 mg (838), and 30 mg (840). Similarly, the effect of [2-AA] CoCl₃ dosage on its adsorption capacity to remove As³⁺ was studied with the adsorbent dosage of 3 mg (842), 5 mg (844), 10 mg (846), 20 mg (848), and 30 mg (850). Further, the effect of [2-AA] CoCl₃ dosage on its adsorption capacity to remove Pb²⁺ was studied with the adsorbent dosage of 3 mg (852), 5 mg (854), 10 mg (856), 20 mg (858), and 30 mg (860). Furthermore, the effect of [2-AA] CoCl₃ dosage on its adsorption capacity to remove Cr³⁺ was studied with the adsorbent dosage of 3 mg (862), 5 mg (864), 10 mg (866), 20 mg (868), and 30 mg (870). The adsorption experiment was carried out by dispersing the adsorbent in a 10 mL solution of 100 ppm each of metal ions, then stirring for 24 h contact time. From FIG. 8B, it can be observed that the percent removal of the heavy metals increases with an increase in the dosage up to 30 mg. However, the adsorption capacity (which factors in the mass of the adsorbent, as shown in equation (1)) increases from 3 to 5 mg. However, an increase in concentrations beyond 5 mg decreases the absorption capacity up to 30 mg (FIG. 8B). Further experiments were conducted with the adsorbent dosage of 5 mg.

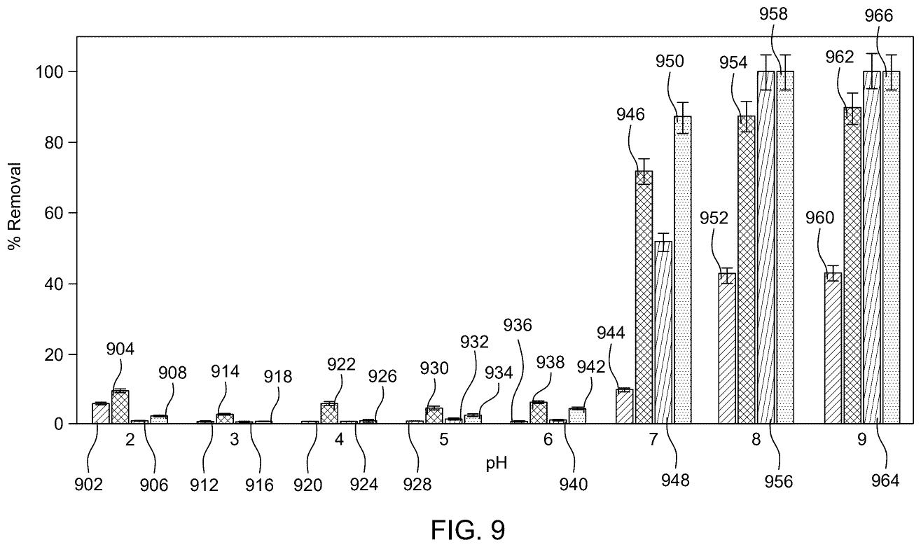

Further, the effect of solution pH on the adsorption efficiency of [2-AA] CoCl₃ was studied, and the results are depicted in FIG. 9. The pH plays a significant role in the adsorption capacity. It can affect the metal speciation through the hydrolysis reaction and the electrostatic interaction between the adsorbent and the adsorbate. A wide pH range (2-9) was investigated in the adsorption experiments. The adsorption efficiency of Cd²⁺, As³⁺, Pb²⁺, and Cr³⁺ at pH 2 (902, 904, 906, 908), pH 3 (912, 914, 916, 918), pH 4 (920, 922, 924, 926), pH 5 (928, 930, 932, 934), pH 6 (936, 938, 940, 942), pH 7 (944, 946, 948, 950), pH 8 (952, 954, 956, 958), and pH 9 (960, 962, 964, 966) was investigated. As shown in FIG. 9, the adsorption efficiency of [2-AA] CoCl₃ increases with an increase in the pH, especially for Pb²⁺ and Cr³⁺, where the percentage removal was more than 99% at pH 8 and 9 without major differences. However, increasing the pH to 9 resulted in the precipitation of the metal ions. Further experiments were performed at pH 8. The pH result agrees with the isoelectric point of MIL, which shows a larger negative charge on the surface above pH 5, as shown in FIG. 5B. This favors the electrostatic interaction between the cationic species and the large negative adsorption sites. In contrast, at lower pH, the MIL exhibits positive active sites, which produce unfavorable electrostatic interaction that causes repulsion between the cationic metal ions and the positively charged surface of MIL. Therefore, it can be understood that the electrostatic interaction is the dominant factor affecting the adsorption behavior of the metal ions.

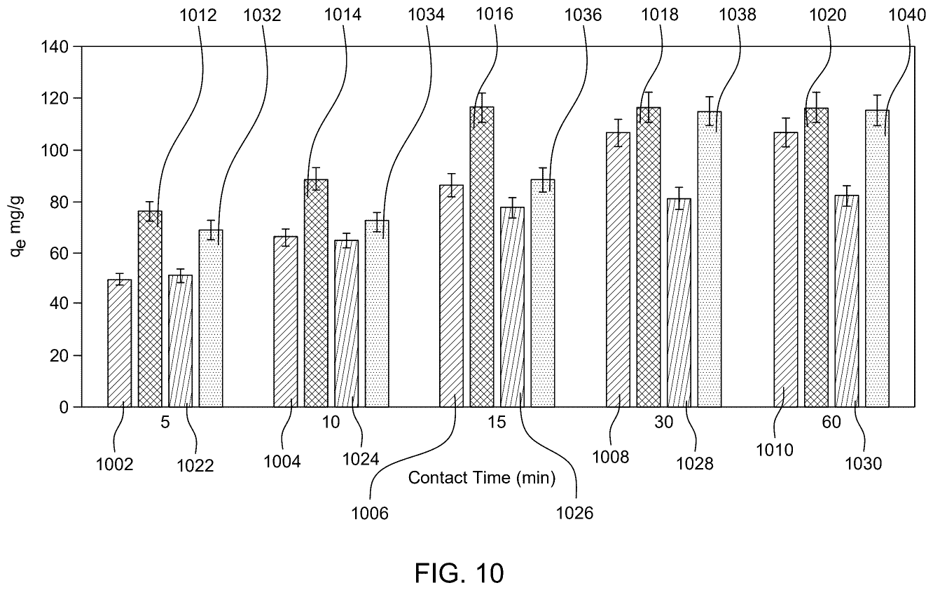

Further, the effect of contact time on the adsorption efficiency of [2-AA] CoCl₃ was studied, and the results of this study are depicted in FIG. 10. The absorption efficiency was studied at 5, 10, 15, 30, and 60 minutes. The adsorption efficiency of Cd²⁺, As³⁺, Pb²⁺, and Cr³⁺ at 5 minutes (1002, 1012, 1022, 1032), 10 minutes (1004, 1014, 1024, 1034), 15 minutes (1006, 1016, 1026, 1036), 30 minutes (1008, 1018, 1028, 1038), and 60 minutes (1010, 1020, 1030, 1040) was investigated. The contact time between the [2-AA] CoCl₃ MIL and metal ions in the solution affects the adsorption efficiency of the adsorbent. As observed in FIG. 10, the adsorption capacity increases with contact time from 5 minutes to 30 minutes. Further increase in contact time to 60 minutes does not increase the adsorption efficiency. However, contact time beyond 60 minutes decreased the adsorption capacity for some of the heavy metal ions. This behavior can be attributed to the saturation of the pores of the adsorbent or gradual ionization leading to the formation of OH. Further absorption experiments were conducted at 60 min to save energy and time.

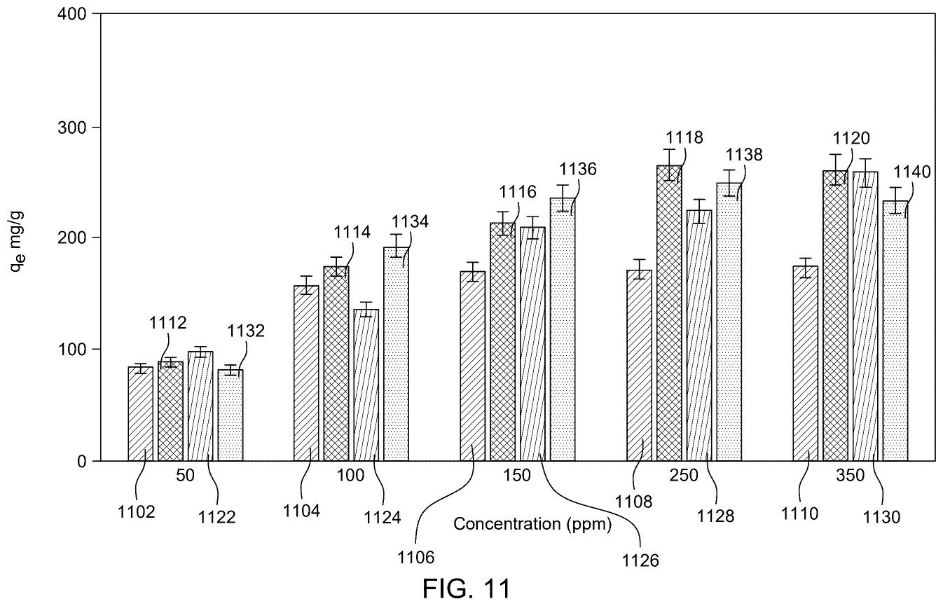

Further, the effect of metal ions concentration on the adsorption capacity of [2-AA] CoCl₃ was studied, and the results of this study are presented in FIG. 11. Generally, the metal ions concentration affects the adsorption capacity of adsorbents (equation 1). The effect of metal ions concentration was studied by varying the initial concentrations of the ions from 50 to 350 mg/L, particularly at 50, 100, 150, 250, and 300 ppm, respectively. The adsorption efficiency of Cd²⁺, As³⁺, Pb²⁺, and Cr³⁺ at 50 ppm (1102, 1112, 1122, 1132), 100 ppm (1104, 1114, 1124, 1134), 150 ppm (1106, 1116, 1126, 1136), 250 ppm (1108, 1118, 1128, 1138), and 300 ppm (1110, 1120, 1130, 1140) was investigated. The results show that the adsorption capacity of [2-AA] CoCl₃increases with the concentration of metal ions up to 250 ppm (FIG. 11). Further increase in concentration beyond 250 ppm results in a decrease in adsorption capacity. This phenomenon may be due to the saturation of the active sites on the MIL. Based on the results, the adsorption capacity between 171-265 mg/g was recorded for the heavy metal ions.

The adsorption processes of the Cd²⁺, As³⁺, Pb²⁺, and Cr³⁺ heavy metal ions on the [2-AA] CoCl₃ adsorbent were better understood using kinetic adsorption parameters. These parameters are typically derived from the pseudo-first-order and pseudo-second-order kinetic models mathematically expressed by the Lagergren rate equation (2) and the Ho and Mckay rate equation (3).

$$ln ( {q}_{e} - {q}_{t} ) = ln {q}_{e} - {k}_{1} t \qquad ( 2 )$$

$$\frac{t}{{q}_{t}} \frac{1}{{k}_{2} {q}_{e}^{2}} + \frac{t}{{q}_{e}} \qquad ( 3 )$$

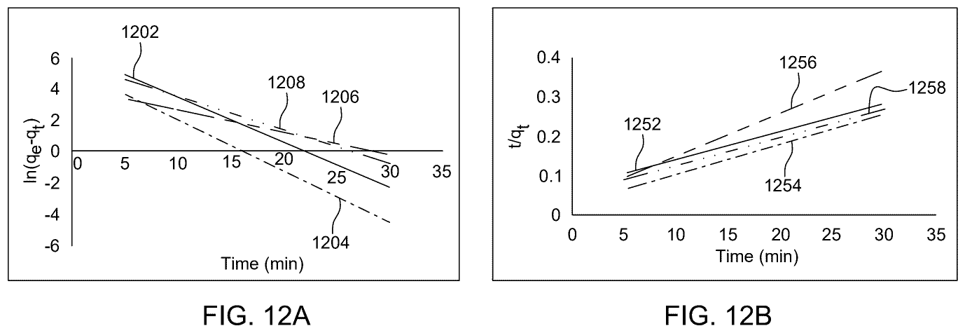

The qₜ (mg/g) and qₑ (mg/g) denote the amount of metal ions adsorbed at time t (min) and equilibrium, respectively. Similarly, the k₁ (min⁻¹) and k₂ (g/mg·min) denote the pseudo-first-order and pseudo-second-order rate constants. If the adsorption processes for the heavy metal ions Cd²⁺ (1202), As³⁺ (1204), Pb²⁺ (1206), and Cr³⁺ (1208) by [2-AA] CoCl₃ follow the pseudo-first-order kinetic model, the plot of ln(qₑ−qₜ) versus t(min) shown in FIG. 12A was expected to give a straight line with an intercept of lnqₑ and slope of −k₁.

Similarly, if the adsorption processes proceeded via the pseudo-second-order kinetics, then the plot of t/qₜ versus t(min) presented in FIG. 12B was expected to give a straight line with an intercept of 1/k₂qₑ² and slope of 1/qₑ. Therefore, the obtained slopes and intercepts from the respective pseudo-first-order and pseudo-second-order plots were used to calculate the kinetic parameters k₁, k₂, and theoretical (cal) summarized in Table 1. Consequently, the higher R² values for the pseudo-second-order plots for all the heavy metal ions, Cd²⁺ (1252), As³⁺ (1254), Pb²⁺ (1256), and Cr³⁺ (1258), adsorption on the [2-AA] CoCl₃ indicate that the adsorption processes proceeded via the pseudo-second-order pathway; thus, the process is controlled by the physisorption mechanism. Based on this, it may be inferred that the interaction between the heavy metal ions and [2-AA] CoCl₃ is electrostatic between electron-rich sites of the adsorbent and the metal ions. In addition, the closeness of experimental adsorption capacity (qₑ(expt)) with the pseudo-second-order calculated adsorption capacity (qₑ(cal)) corroborates that the adsorption processes proceeded via the pseudo-second-order pathway.

TABLE 1
Kinetic parameters for adsorption of heavy metal ions by [2-AA] CoCl3 MIL

| Pseudo first order | | | | | Pseudo second order | | |
|---|---|---|---|---|---|---|---|
| | qₑ (exp) | | qₑ (cal) | | k₂(10⁴) | Qe (cal) | |
| Ion | (mg/g) | k₁ (min⁻¹) | (mg/g) | R² | (g/mg · min) | (mg/g) | R² |
| Cd | 106.6 | 0.286 | 544 | 0.9352 | 6.84 | 142.8 | 0.992 |
| As | 116.4 | 0.325 | 190 | 0.8682 | 20.6 | 131.6 | 0.9876 |
| Pb | 82 | 0.14 | 56.8 | 0.9634 | 28.8 | 91.7 | 0.9964 |
| Cr | 115.2 | 0.215 | 284 | 0.9142 | 9.35 | 140.8 | 0.9673 |

The adsorption isotherm studies were carried out to gain insight into the nature of the interaction between the [2-AA] CoCl₃ adsorbent and the heavy metal ions. The Langmuir and Freundlich isotherms models expressed by linear equations (4) and (5) respectively were used.

$$\frac{{C}_{e}}{{q}_{e}} = \frac{1}{{K}_{L} {q}_{m}} + \frac{{C}_{e}}{{q}_{m}} \qquad ( 4 )$$

$$ln {q}_{e} = ln {K}_{F} + \frac{1}{n} ln {C}_{e} \qquad ( 5 )$$

Cₑ(mg/L) and qₑ(mg/g) denote the equilibrium concentration of adsorbate and adsorption capacity of the adsorbent, respectively. K_{L} and qₘ indicate Langmuir equilibrium constant and the maximum adsorption capacity of the adsorbent, respectively. K_{F} and n are Freundlich constants for a given adsorbate and adsorbent.

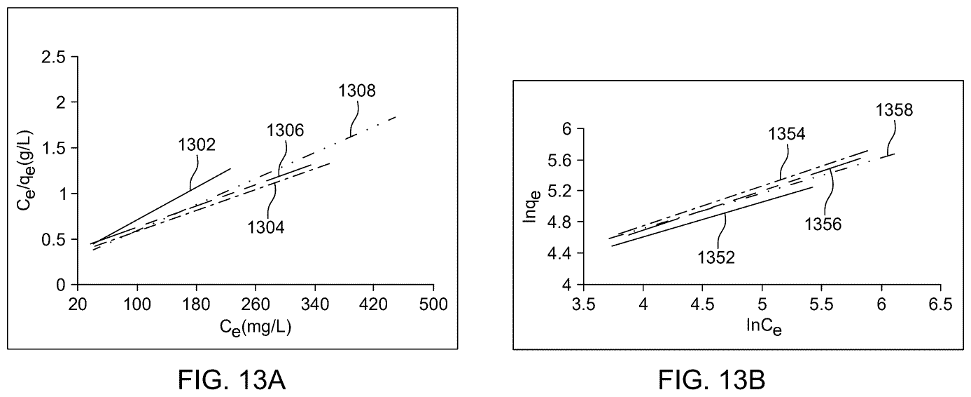

The Langmuir isotherm model assumes that the adsorption of the heavy metal ions occurs homogeneously on the surface of the [2-AA] CoCl₃ adsorbent using specific adsorption sites and energies. This model considered that steric hindrances and lateral interactions between adsorbate (heavy metal ions in this case) are not significant. Contrarily, the Freundlich isotherm model presumes that the adsorption of the heavy metal ions occurs heterogeneously, resulting in uneven distribution of adsorption energies over the [2-AA] CoCl₃ adsorption surfaces. Therefore, by plotting Cₑ/qₑ against Cₑ for the heavy metal ions Cd²⁺ (1302), As³⁺ (1304), Pb²⁺ (1306), and Cr³⁺ (1308) using equation (4), to get a slope equal to 1/qₘ and intercept of 1/K_{L}qₘ (FIG. 13A), the K_{L}, which relates directly with adsorption energy, and qₘ, which signifies the monolayer adsorption capacity, can both be determined.

Similarly, the plot of lnqₑ against lnCₑ (using equation 5) gives a slope equal to 1/n and intercept of ln K_{F} (FIG. 13B), and the constants n and K_{F} for the heavy metal ions Cd²⁺ (1352), As³⁺ (1354), Pb²⁺ (1356), and Cr³⁺ (1358) adsorption is determined accordingly. The adsorption isotherm parameters are summarized in Table 2. Both models' correlation coefficient values (R²) are used to evaluate the model that best fits the nature of the interaction between the [2-AA] CoCl₃ adsorbent and the heavy metal ions, Cd²⁺ (1352), As³⁺ (1354), Pb²⁺ (1356), and Cr³⁺ (1358). Consequently, the R² values of the Langmuir adsorption isotherm are more than the R² values of the Freundlich adsorption isotherm; thus, the heavy metal ions adsorption isotherm was best described by the Langmuir model, which implies that the adsorption occurs homogeneously on the surface of the [2-AA] CoCl₃ adsorbent. In addition, the Langmuir model has shown that the [2-AA] CoCl₃ adsorbent has demonstrated remarkable performance in removing these heavy metal ions with maximum adsorption capacity (qm) in the range of 227-357 mg/g. The adsorption capacity of Cd²⁺, Pb²⁺, As³⁺, and Cr³⁺ onto [2-AA] CoCl₃ adsorbent was compared with other adsorbents in literature (Table 3). The results suggest that [2-AA] CoCl₃ adsorbent performs exceptionally well in the adsorption of Cd²⁺, Pb²⁺, As³⁺, and Cr³⁺ compared to the adsorbents earlier reported.

TABLE 2
Isotherm parameters for adsorption of heavy
metal ions on [2-AA] CoCl₃ MIL

| Langmuir isotherm | | | | | | |
|---|---|---|---|---|---|---|
| | qm | KL(10³) | | Freundlich isotherm | | |
| Ion | (mg/g) | (L/mg) | R² | n | KF | R2 |
| Cd | 227.3 | 16.3 | 0.9789 | 2.22 | 16.6 | 0.9096 |
| As | 357.1 | 9.3 | 0.9705 | 1.94 | 14.7 | 0.8959 |
| Pb | 344.8 | 8.7 | 0.9875 | 2.05 | 15.8 | 0.9502 |
| Cr | 285.7 | 15 | 0.9677 | 2.2 | 18.1 | 0.8247 |

TABLE 3
Comparison of ([2-AA] CoCl₃)
adsorbent with published work

| | Metal | Maximum | |
|---|---|---|---|
| Adsorbent and method | ion | adsorption capacities | |
| A mixture of magnetic | Cd | 0.300 | mmol/g |
| graphite oxide and sand as | Pb | 0.608 | mmol/g |
| a medium in a fixed- | Cr | 0.484 | mmol/g |
| bed column | As | 0.272 | mmol/g |
| Cassava root husk-derived | Cd | 44.27 | mg/g |
| biochar loaded with ZnO | Pb | 42.05 | mg/g |
| nanoparticles | Cr | 39.52 | mg/g |
| | As | 28.37 | mg/g |
| Shanghai silty clay (SSC) | Cd | 8.90 | mg/g |
| | Pb | 26.46 | mg |
| | Cr | 1.85 | mg/g |
| | As | 2.80 | mg/g |
| 2-anthracene ammonium | Cd | 227.3 | mg/g |
| trichlorocobaltate (II) | Pb | 344.8 | mg/g |
| ([2-AA] CoCl₃)* | Cr | 285.7 | mg/g |
| | As | 357.1 | mg/g |

*Adsorbent of the present disclosure

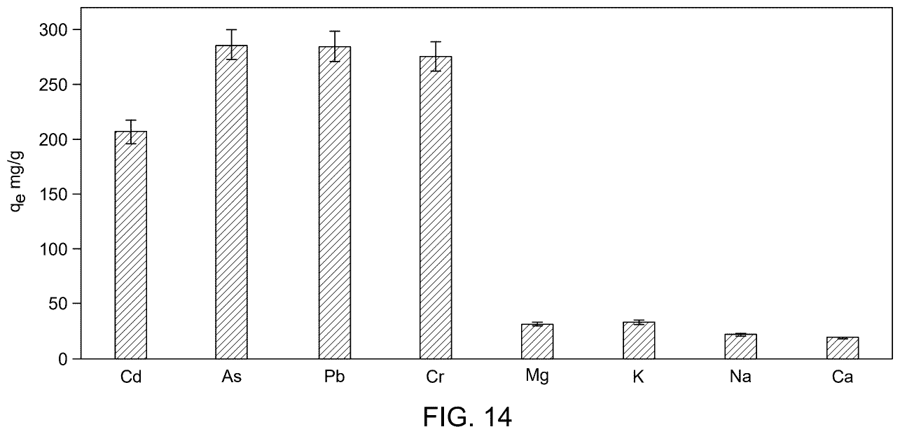

Further, the selectivity of [2-AA] CoCl₃ for Cd²⁺, Pb²⁺, As³⁺, and Cr³⁺ was studied by introducing 150 ppm each of Ca²⁺, K⁺, Na⁺, and Mg²⁺ as competitive ions in the sample solution containing 150 ppm each of Cd²⁺, Pb²⁺, As³⁺, and Cr³⁺. It was observed that even in the presence of other competitive metal ions, the [2-AA] CoCl3 exhibited superior adsorption performance Cd²⁺, Pb²⁺, As³⁺, and Cr³⁺ (FIG. 14), with adsorption capacity in the range of 206-286 mg/g. On the other hand, the adsorption capacity of Ca²⁺, K⁺, Na⁺, and Mg²⁺ was within 20-34 mg/g (Table 4).

The selectivity coefficient (K_{M/M′}) of [2-AA] CoCl₃ for the targeted heavy metal ions (M) over other competitive metal ions (M′) is calculated using the equation (6):

$${K}_{M / {M}^{′}} = \frac{{K}_{d} ( M )}{{K}_{d} ( {M}^{′} )} \qquad ( 6 )$$

where K_{d} signifies the distribution coefficient of the metal ions and is calculated using equation (7):

$${K}_{d} = ( \frac{{C}_{o} - {C}_{e}}{{C}_{e}} ) * \frac{V}{m} \qquad ( 7 )$$

A significant value of K_{d} implies large adsorption of the metal ion by adsorbent and vice-versa. Table 4 shows the K_{d} values of all the ions, and it is observed that the Cd²⁺, Pb²⁺, As³⁺, and Cr³⁺ have larger K_{d} values, especially As³⁺ (Kd=460 mL/g) than the Ca²⁺, K⁺, N^{a+}, and Mg²⁺ ions. Similarly, the adsorption capacity of the targeted metal ions is in the range of 206-286 mg/g, while the adsorption capacity of the interfering ions is 20-34 mg/g. In addition, the selectivity coefficient (K_{M/M′}) of each of the targeted metal ions is 2-3 orders of magnitude higher than those of the interfering metal ions. This further confirms the high selectivity of [2-AA] CoCl₃ for the targeted heavy metal ions.

TABLE 4
Selective adsorption of targeted metal ions by [2-AA] CoCl₃

| Metal | Co | Ce | qe | Kd | | | | |
|---|---|---|---|---|---|---|---|---|
| ions | (ppm) | (ppm) | (mg/g) | (mL/g) | KM/Mg | KM/K | KM/Na | KM/Ca |
| Cd | 138 | 35 | 206 | 5.88 | 22.8 | 22.5 | 34.8 | 39.4 |
| As | 143 | 0.62 | 285 | 460 | 1783 | 1760 | 2724 | 3080 |
| Pd | 147 | 4.65 | 284 | 61.2 | 237 | 234 | 362 | 410 |
| Cr | 141 | 3.57 | 275 | 77 | 299 | 295 | 456 | 516 |
| Mg | 145 | 129 | 33.2 | 0.26 | | | | |
| K | 146 | 129 | 33.8 | 0.26 | | | | |
| Na | 141 | 130 | 21.9 | 0.17 | | | | |
| Ca | 145 | 135 | 20.1 | 0.15 | | | | |

### Regeneration Studies

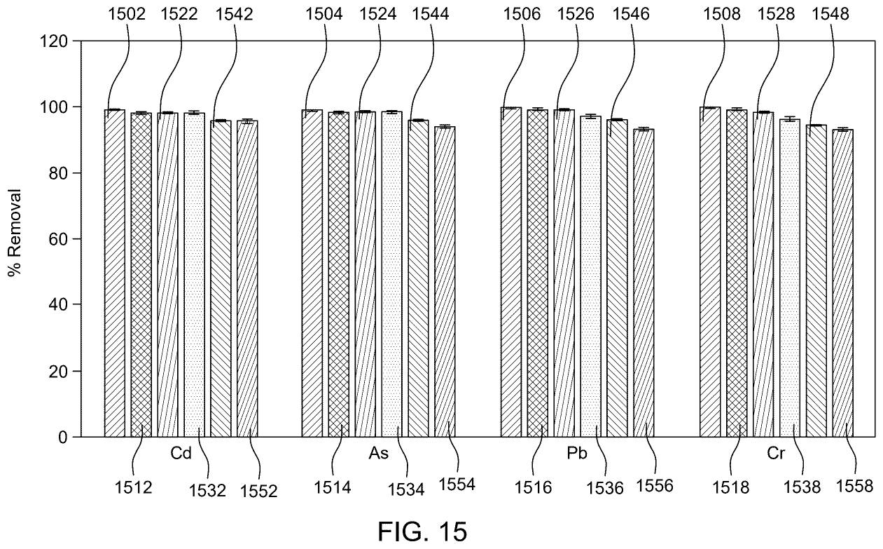

Recycling the adsorbent was studied to evaluate the activity loss and possible reusability of the [2-AA] CoCl₃ MIL after using heavy metal ions adsorption. Thus, the adsorbent was recovered for re-use after the adsorption by centrifuging at 3500 rpm. Then, the adsorbent was washed thoroughly with 1M nitric acid at pH 3 until no residue of the metal ions was detectable in the supernatant solution. Finally, the adsorbent was dried at 50° C. before reuse. The adsorption efficiency of the [2-AA] CoCl₃-based MIL adsorbent for Cd²⁺ for 1^{st} cycle (1502), 2^{nd} cycle (1512), 3^{rd} cycle (1522), 4^{th} cycle (1532), 5^{th} cycle (1542), and 6^{th} cycle (1552); for As³⁺—1^{st} cycle (1504), 2^{nd} cycle (1514), 3^{rd} cycle (1524), 4^{th} cycle (1534), 5^{th} cycle (1544), and 6^{th} cycle (1554); for Pb²⁺—1^{st} cycle (1506), 2^{nd} cycle (1516), 3^{rd} cycle (1526), 4^{th} cycle (1536), 5^{th} cycle (1546), and 6^{th} cycle (1556); and Cr³⁺—1^{st} cycle (1508), 2^{nd} cycle (1518), 3^{rd} cycle (1528), 4^{th} cycle (1538), 5^{th} cycle (1548), and 6^{th} cycle (1558), respectively, as depicted in FIG. 15. From the FIG. 15, it can be observed that the [2-AA] CoCl₃ MIL could be reused six times with excellent adsorption efficiency of more than 93%.

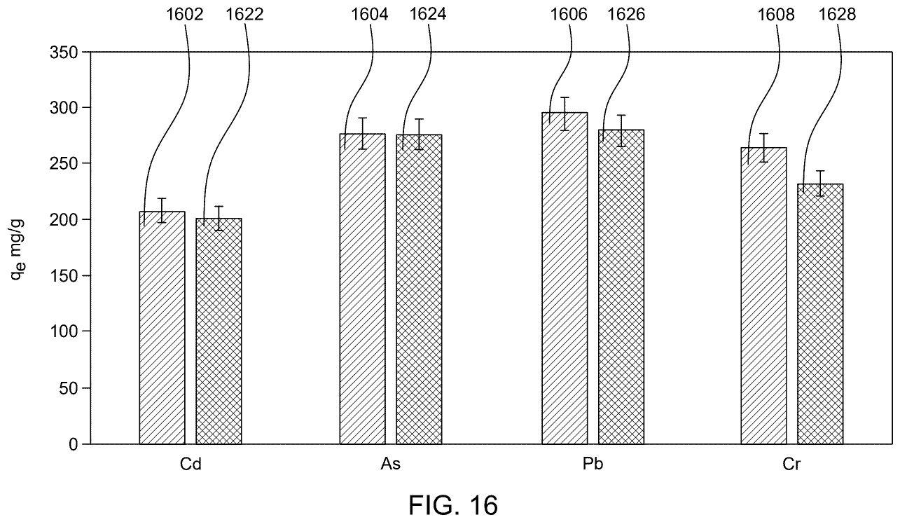

Similar results were obtained when 150 ppm each of Cd²⁺, As³⁺, Pb²⁺, and Cr³⁺ metal ions were added to real wastewater (1602, 1604, 1606, 1608) and groundwater resources (1622, 1624, 1626, and 1628), as shown in FIG. 16. This suggests the practicality of the [2-AA] CoCl₃ MIL adsorbent in the selective removal of Cd²⁺, Pb²⁺, As³⁺, and Cr³⁺ metal ions in complex matrices.

This present disclosure depicts the adsorption potential of two 2-anthracene ammonium-based magnetic ionic liquids (MILs) in the removal of Cd²⁺, Pb²⁺, As³⁺, and Cr³⁺ from ground and wastewater resources. The MILs, 2-anthracene ammonium tetrachloroferrate (III) or 2-anthracene ammonium trichlorocobaltate (II) ([2-AA] CoCl₃), were synthesized by protonation of 2-aminoanthracene, followed by complexation with FeCl₃/CoCl₂. The [2-AA] CoCl₃ demonstrated a slightly higher adsorption capacity to remove the targeted metal ions and was used to evaluate the adsorption parameters, kinetics, and isotherms studies. The [2-AA] CoCl₃ performed efficiently in both neutral and alkaline solutions, and equilibrium adsorption was recorded within 60 minutes of contact time. The adsorption process proceeded via the pseudo-second-order pathway, and the Langmuir isotherm model fitted the adsorption process, with maximum adsorption capacity in the range of 227-357 mg/g. In addition, the [2-AA] CoCl₃ was selective to the targeted metal ions with a large distribution coefficient and selectivity coefficient in the order of 2-3 against the interfering ions. The [2-AA] CoCl₃ has demonstrated practicality as an adsorbent for the selective removal of the targeted metal ions with an adsorption efficiency of above 90% even after re-using it six (6) times with similar performance in real raw underground and wastewater samples.

Obviously, numerous modifications and variations of the present disclosure are possible in light of the above teachings. It is therefore to be understood that within the scope of the appended claims, the invention may be practiced otherwise than as specifically described herein.

1. (canceled)

2. The method of claim 10, wherein the 2-anthracene ammonium magnetic ionic liquid comprises a [FeCl₄]⁻ or a [CoCl₃]⁻ ion.

3. The method of claim 2, wherein the adsorbent has a thermal stability up to a temperature of 400° C.

4. The method of claim 2, wherein the adsorbent is 2-anthracene ammonium trichlorocobaltate.

5. The method of claim 4, wherein the 2-anthracene ammonium trichlorocobaltate is in the form of nanoflakes having an average diameter of 2 to 10 μm prior to the mixing.

6. The method of claim 4, wherein the 2-anthracene ammonium trichlorocobaltate is in the form of nanoflakes having an average thickness of 1 to 8 μm the mixing.

7. The method of claim 4, wherein the 2-anthracene ammonium trichlorocobaltate is in the form of nanoflakes and the nanoflakes are to 8 times thicker after the mixing.

8. The method of claim 2, wherein the adsorbent is 2-anthracene ammonium tetrachloroferrate having an adsorption capacity in the range of 3 to 80 mg/g.

9. The method of claim 4, having an adsorption capacity in the range of 10 to 80 mg/g.

10. A method of reducing a contaminant concentration in an aqueous solution, comprising:
mixing an adsorbent with the aqueous solution containing the contaminant to adsorb at least a portion of the contaminant from the aqueous solution into the adsorbent,
wherein the adsorbent comprises a 2-anthracene ammonium magnetic ionic liquid (MIL).

11. The method of claim 10, wherein the concentration of the contaminant in the aqueous solution is 25 to 100 ppm before the mixing, and 0 to 5 ppm after the mixing, wherein the adsorbent has an adsorption capacity of 23 to 60 mg/g.

12. The method of claim 10, wherein the aqueous solution is at 10 to 50° C. during the mixing.

13. The method of claim 10, wherein the contaminant is at least one metal ion.

14. The method of claim 13, wherein the metal ion is at least one metal selected from the group consisting of Cd²⁺, As³⁺, Pb²⁺ and Cr³⁺.

15. The method of claim 14, wherein the 2-anthracene ammonium trichlorocobaltate adsorbent maintains an adsorption efficiency of at least 90% for removing metal ions over at least 5 cycles of the mixing.

16. (canceled)
